(19) United States
(12) Patent Application Publication
(10) Pub. No.: US 2026/0150112 A1
(43) Pub. Date: May 28, 2026

(54) COMMUNICATION METHOD, TERMINAL DEVICE, AND NETWORK DEVICE

(71) Applicant: QUECTEL WIRELESS SOLUTIONS CO., LTD., Shanghai (CN)

(72) Inventors: Zheng ZHAO, Shanghai (CN); Ling LYU, Frisco, TX (US)

(21) Appl. No.: 19/432,737

(22) Filed: Dec. 24, 2025

Related U.S. Application Data
(63) Continuation of application No. PCT/CN2024/134018, filed on Nov. 22, 2024.

(51) Int. Cl. H04W 72/232; H04W 74/0833

(52) U.S. Cl. CPC H04W 72/232; H04W 74/0833

(57) ABSTRACT

A communication method, a terminal device, and a network device are provided. One example method includes: receiving first downlink control information (DCI) from a network device, wherein the first DCI is used to trigger a random access procedure or used to indicate a first physical random access channel (PRACH) resource.

### CROSS-REFERENCE TO RELATED APPLICATIONS

This application is a continuation of International Application No. PCT/CN2024/134018, filed on Nov. 22, 2024, the disclosure of which is hereby incorporated by reference in its entirety.

### TECHNICAL FIELD

The present application relates to the field of communications technologies, and more specifically, to a communication method, a terminal device, and a network device.

### BACKGROUND

A random access procedure is a process between a step in which a terminal device starts to attempt to access a network by transmitting a random access preamble by using a physical random access channel (physical random access channel, PRACH) and a step in which the terminal device establishes a basic signaling connection to the network. This process is a key step of establishing an initial communication connection between the terminal device and the network. Therefore, the random access procedure needs to be optimized.

### SUMMARY

The present application provides a communication method, a terminal device, and a network device. Various aspects of the present application are described below.

According to a first aspect, a communication method is provided, including: receiving, by a terminal device, first DCI transmitted by a network device, where the first DCI is used to trigger a random access procedure or used to indicate a first PRACH resource.

According to a second aspect, a communication method is provided, including: transmitting first DCI to a terminal device, where the first DCI is used to trigger a random access procedure or used to indicate a first PRACH resource.

According to a third aspect, a terminal device is provided, including: a transceiver unit, receiving first DCI transmitted by a network device, where the first DCI is used to trigger a random access procedure or used to indicate a first PRACH resource.

According to a fourth aspect, a network device is provided, including: a transceiver unit, transmitting first DCI to a terminal device, where the first DCI is used to trigger a random access procedure or used to indicate a first PRACH resource.

According to a fifth aspect, a terminal device is provided, including a transceiver, a memory, and a processor, where the memory is configured to store a program, and the processor is configured to invoke the program in the memory and control the transceiver to receive or transmit a signal, to cause the terminal device to execute the method according to the first aspect.

According to a sixth aspect, a network device is provided, including a transceiver, a memory, and a processor, where the memory is configured to store a program, and the processor is configured to invoke the program in the memory and control the transceiver to receive or transmit a signal, to cause the network device to execute the method according to the second aspect.

According to a seventh aspect, an apparatus is provided, including a processor configured to invoke a program from a memory, to cause the apparatus to execute the method according to the first aspect or the second aspect.

According to an eighth aspect, a chip is provided, including a processor configured to invoke a program from a memory, to cause a device on which the chip is installed to execute the method according to the first aspect or the second aspect.

According to a ninth aspect, a computer-readable storage medium is provided, where the computer-readable storage medium stores a program, and the program causes a computer to execute the method according to the first aspect or the second aspect.

According to a tenth aspect, a computer program product is provided, where the computer program product includes a program, and the program causes a computer to execute the method according to the first aspect or the second aspect.

According to an eleventh aspect, a computer program is provided, where the computer program causes a computer to execute the method according to the first aspect or the second aspect.

In embodiments of the present application, a network device transmits first DCI to a terminal device, to trigger a random access procedure or indicate a first PRACH resource, so as to provide the terminal device with an additional random access opportunity or resource, which facilitates fast restoration of uplink synchronization, optimizes network resource allocation, and improves system flexibility.

### BRIEF DESCRIPTION OF THE DRAWINGS

FIG. 1 is an example diagram of a system architecture of a wireless communications system to which embodiments of the present application are applicable.

FIG. 2 is a schematic flowchart of a wireless communication method according to an embodiment of the present application.

FIG. 3 is a schematic structural diagram of a terminal device according to an embodiment of the present application.

FIG. 4 is a schematic structural diagram of a network device according to an embodiment of the present application.

FIG. 5 is a schematic diagram of an apparatus for communication according to an embodiment of the present application.

### DETAILED DESCRIPTIONS OF THE EMBODIMENTS

The technical solutions in the present application are described below with reference to the accompanying drawings.

### Wireless Communications System

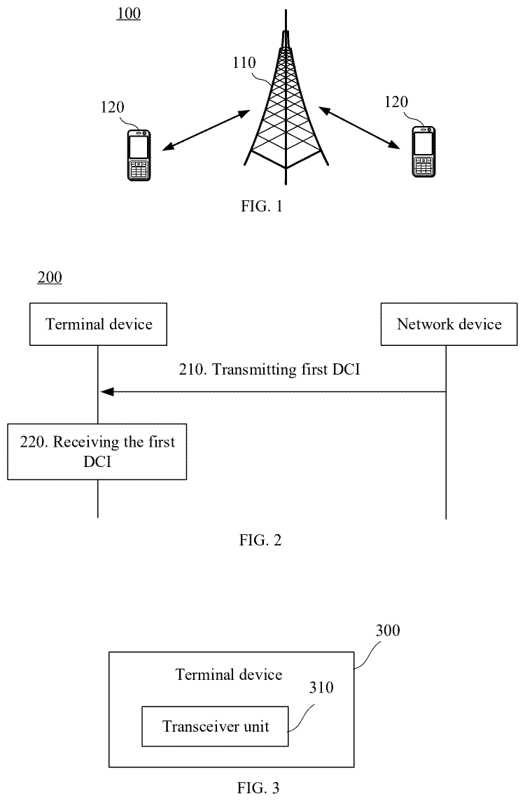

FIG. 1 is an example diagram of a system architecture of a wireless communications system 100 to which embodiments of the present application are applicable. The wireless communications system 100 may include a network device 110 and a terminal device 120. The network device 110 may be a device that communicates with the terminal device 120. The network device 110 may provide network coverage for a specific geographic area, and may communicate with a terminal device 120 within the coverage. The terminal device 120 may access a network such as a wireless network by using the network device 110. Optionally, the wireless communications system 100 may further include another network entity such as a network controller or a mobility management entity. This is not limited in the embodiments of the present application.

It should be understood that the technical solutions in the embodiments of the present application may be applied to various communications systems, for example, a fifth generation (fifth generation, 5G) system or new radio (new radio, NR), a long term evolution (long term evolution, LTE) system, an LTE frequency division duplex (frequency division duplex, FDD) system, and LTE time division duplex (time division duplex, TDD) system. The technical solutions provided in the present application may be further applied to a future communications system, such as a sixth generation mobile communications system or a satellite communications system.

In the embodiments of the present application, the terminal device may also be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in the embodiments of the present application may be a device providing a user with voice and/or data connectivity and capable of connecting people, objects, and machines, such as a handheld device or vehicle-mounted device having a wireless connection function. The terminal device may be further a mobile phone (mobile phone), a tablet computer (Pad), a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in smart grid (smart grid), a wireless terminal in transportation safety (transportation safety), a wireless terminal in a smart city (smart city), a wireless terminal in a smart home (smart home), or the like. Optionally, the terminal device may function as a base station. For example, the terminal device may function as a scheduling entity, which provides a sidelink signal between terminal devices in vehicle-to-everything (vehicle to everything, V2X), device-to-device (device to device, D2D), or the like. For example, a cellular phone and a vehicle communicate with each other by using a sidelink signal. A cellular phone and a smart home device communicate with each other, without relaying a communication signal by using a base station.

In the embodiments of the present application, the network device may be a device for communicating with a terminal device. The network device may be an access network device or a radio access network device. For example, the network device may be a base station. The base station may broadly cover various names below, or may be replaced with the following names, such as a NodeB (NodeB), an evolved NodeB (evolved NodeB, eNB), a next generation NodeB (next generation NodeB, gNB), a relay station, a transmitting and receiving point (transmitting and receiving point, TRP), a transmitting point (transmitting point, TP), a master eNodeB (MeNB), a secondary eNodeB (SeNB), a multi-standard radio (MSR) node, a home base station, a network controller, an access node, a wireless node, an access point (access point, AP), a transmission node, a transceiver node, a baseband unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communications, a network-side device in a 6G network, a device that functions as a base station in a future communications system, or the like. The base station may support networks of a same access technology or different access technologies. A specific technology and a specific device form used by the network device are not limited in the embodiments of the present application. The base station may support networks of a same access technology or different access technologies. A specific technology and a specific device form used by the network device are not limited in the embodiments of the present application.

In addition, the base station may be fixed or mobile. For example, a helicopter or an unmanned aerial vehicle may be configured to function as a mobile base station, and one or more cells may move depending on a location of the mobile base station. In another example, a helicopter or an unmanned aerial vehicle may be configured to serve as a device that communicates with another base station.

The network device and the terminal device may be deployed on land, including being indoors or outdoors, handheld, or vehicle-mounted, may be deployed on a water surface, or may be deployed on a plane, a balloon, or a satellite in the air. In the embodiments of the present application, a scenario in which the network device and the terminal device are located is not limited.

It should be understood that all or some of functions of the communications device in the present application may also be implemented by software functions running on hardware, or by virtualization functions instantiated on a platform such as a cloud platform.

In a wireless communications system, after being powered on, a user needs to establish downlink and uplink synchronization with a system. For example, in an LTE system or an NR system, when the user performs initial access, the user initiates a connection request to a network device when the user is restored from a sleep state, or the user is handed over to a new cell, the user needs to perform downlink synchronization before performing uplink synchronization and access. A connection is re-established by using a PRACH, and the terminal device may request the network device to allocate a resource to the terminal device, so as to perform data transmission or other communication. When traffic changes, the terminal device may dynamically request a required resource by using the PRACH, so as to improve network flexibility. A conflict probability may be effectively reduced in a PRACH procedure by using a random preamble, and the conflict is processed by using a retransmission mechanism. There are a plurality of events that trigger a random access procedure, for example, initial access from a radio resource control (radio resource control, RRC) idle (RRC_IDLE) state, an RRC connection reestablishment process, a scheduling request (scheduling request, SR) failure, and beam failure recovery. Therefore, the random access procedure may be performed when the terminal device is in the RRC idle state, an RRC inactive (RRC_INACTIVE) state, or an RRC connected (RRC_CONNECTED) state. To enable a terminal device in a network to have an opportunity to perform random access, the network device needs to configure a PRACH resource for the terminal device, so as to receive a random access preamble from the terminal device. In an example, the terminal device may obtain a PRACH configuration by using higher layer signaling, so as to obtain a PRACH resource in time domain. Each PRACH configuration has a corresponding index, each PRACH configuration corresponds to random access occasion (random access occasion, RO) distribution, and the RO distribution is generally defined by a radio frame index, an intra-frame subframe number, and a start symbol in a slot.

In an actual random access procedure, the terminal device first monitors system information such as a system information block (system information block, SIB) 1 and a SIB 2 transmitted by the network device, so as to learn configuration and availability of the PRACH resource. Then, the terminal device selects a PRACH preamble based on the obtained PRACH configuration to perform random access. The terminal device transmits the random access preamble in a predetermined PRACH slot, and the network device performs processing after receiving the preamble.

In the wireless communications system, the network device needs to constantly monitor a PRACH channel and receives the random access preamble transmitted by the terminal device. Energy consumption of the network device mainly exists in a process of processing a random access request, including phases such as signal reception, decoding, resource allocation, and responding. Decoding preambles of a plurality of terminal devices and detecting a collision require a relatively high signal processing capability, and especially in a high load environment, the network device needs to invest more computing resources, which increases the energy consumption. Configuration of a PRACH resource (for example, allocation in frequency domain and time domain) affects the energy consumption of the network device. If excessive resources are allocated for PRACH monitoring, invalid resource occupancy and processing overheads are increased. Activation and management of an additional PRACH resource (for example, an enhanced PRACH for a special scenario) also increase the energy consumption of the network device. In a scenario in which the density of terminal devices is high, a frequency of a random access conflict increases, the network device needs to additionally process retransmission and resolve the conflict, and consequently, the energy consumption is further increased. The network device needs to perform interference cancellation on a received preamble signal, especially in a cell with large coverage or a high-interference environment. Such an operation requires a relatively high computing capability, which increases the energy consumption.

The PRACH procedure is a periodic and always existing process, PRACH periodicity can only be changed semi-statically, and these resources cannot be dynamically adjusted to adapt to a change in traffic load or to save energy at the network device. In such a cell, even if there is no or light traffic, PRACH reception still needs to be performed frequently, which consumes network energy. According to the current 3GPP specifications, a PRACH resource cannot be effectively and dynamically adjusted to adapt to a change in traffic load or demand.

Processing and resource management of a PRACH are important parts of the energy consumption of the network device, and especially in the current and future complex network environments, PRACH load is significantly different in different wireless communication scenarios. For example, in a high-speed mobile scenario, during a running peak hour of a high-speed railway or an internet of vehicles or in a relatively small time interval, a user moves fast, and a serving cell is frequently handed over. For another example, in a large-scale internet of things scenario corresponding to a smart city, a large quantity of internet of things devices (for example, a sensor and an intelligent terminal) access a network, where most devices are low-power devices, a transmission interval is long, but there is a periodic peak. When a large quantity of devices attempt to access at a specific time, short-term congestion of a PRACH channel may be caused. In an emergency or a disaster scenario, a sudden event causes a large quantity of users or devices to access simultaneously (for example, making an emergency call or uploading real-time data). When a network is partly damaged, instantaneous high load may also exist, and a large quantity of users simultaneously transmit random access requests, which tends to cause channel congestion and a preamble conflict. In an indoor scenario, users are concentrated in closed space (for example, a shopping mall or a conference center), and a quantity of persons fluctuates greatly. Although data communication is mostly required for medium-speed and low-speed data, a quantity of users may be large. An access conflict may occur when the density of users is high, and load fluctuates significantly as the quantity of users changes.

Therefore, the system needs to have capability to dynamically adjust a PRACH resource based on load, thereby reducing energy waste caused by repeatedly waking up to perform detection when excessive PRACH resources are configured in a case of low load, and also reducing energy consumption of the network device that is caused by an access collision and excessive ineffective detection due to insufficient PRACH resources in a case of relatively high load. For example, in non-peak hours, PRACH monitoring resources are reduced, and in low traffic hours, some processing units of the network device may enter a low power mode, and only a minimum PRACH monitoring capability is maintained. When PRACH resources are increased in peak hours, PRACH conflicts may be reduced and a probability of the random access collision is decreased, thereby reducing energy consumption caused by repeated processing.

The PRACH resource is adaptively adjusted in time domain, so that the network device may reduce unnecessary monitoring. In principle, the network device may change a PRACH configuration by updating system information, performing RRC reconfiguration, or the like. However, frequent system information updating or frequent RRC reconfiguration also adversely affects network energy saving and signaling overheads.

Therefore, in the embodiments of the present application, a network device may transmit one or more PRACH configurations to a terminal device, and dynamically adjust a PRACH configuration used by the terminal device, so that PRACH transmission can be adaptive to changes in factors such as current traffic and load, a network energy saving requirement, distribution of terminal devices, and a time, thereby optimizing resource utilization and balancing access performance of the terminal devices.

It may be understood that, for a legacy terminal device, for example, a terminal device supporting a relatively low protocol version (for example, a release 18 in NR and a previous version thereof), the network device indicates a PRACH configuration for the terminal device by using system information or an RRC message, where the configuration is referred to as a basic PRACH configuration or a reference PRACH configuration below. Various PRACH parameters included in the basic PRACH configuration may be adjusted, but need to be updated by using system information or an RRC message. The basic PRACH configuration may also be used by a terminal device supporting a higher version (for example, a release 19 in NR and a subsequent protocol version thereof). In addition, the terminal device supporting the higher version may further accept one or more additional PRACH configurations transmitted by the network device, that is, the terminal device can obtain an additional PRACH resource to perform uplink access. In the future, there may be more terminal devices supporting the higher version, one or more additional PRACH configurations are provided for the terminal devices, and a terminal device is dynamically instructed to use a PRACH configuration that is in the additional PRACH configurations and that is adapted to a current scenario, so that access efficiency of a wireless network can be significantly improved, which is especially applicable to high-density, low-latency and high-speed mobile communication scenarios, and network energy saving can be implemented when an uplink access requirement is met.

In an NR system, RRC states are expanded based on RRC states in LTE, to adapt to more application scenarios and more complex network requirements. A new RRC state and some mechanism optimization are introduced to the NR system, and main RRC states include an RRC idle state, an RRC connected state, and an RRC inactive state. In the RRC idle state, a terminal device does not establish an RRC connection to a network device, and only receives cell broadcast information and monitors a paging message. In the RRC connected state, the terminal device establishes an RRC connection to the network device, and interaction of real-time data and control signaling may be performed to maintain real-time communication with the network device. The RRC inactive state is a new state specific to the NR system, and introduced to a release 15 in NR and a subsequent version. The RRC inactive state is between the RRC idle state and the RRC connected state, and is used for balancing power consumption and signaling efficiency. Unlike that in the idle state, the terminal device in the inactive state does not need to release a connection, but can be quickly restored to the connected state, and power consumption and signaling burden can be significantly reduced when compared with that in RRC connected state. When data transmission is completed, the network device may switch the terminal device from the RRC connected state to the inactive state, to reduce power consumption while maintaining a certain connection context. When the terminal device needs to transmit data, the terminal device may return to the connected state through a fast restoration process without reestablishing a complete RRC connection. If the terminal device has no data interaction for a long time, the network device may release the terminal device to the idle state.

In a wireless communications system (for example, an LTE system and an NR system), downlink control information (downlink control information, DCI) is control information transmitted by a network device by using a physical downlink control channel (physical downlink control channel, PDCCH), and is used for allocating a wireless resource to a terminal device or triggering a specific operation. When the terminal device is in the RRC connected state or in the RRC idle state/RRC inactive state, the terminal device receives different signaling.

When the terminal device is in the RRC idle state, only DCI scrambled by using a paging radio network temporary identifier (paging-radio network temporary identifier, P-RNTI) is detected. When the terminal device is in the RRC connected state, the terminal device detects both the DCI scrambled by using the P-RNTI and DCI scrambled by using a cell radio network temporary identifier (cell-radio network temporary identifier, C-RNTI). A random access channel (random access channel, RACH) procedure based on a PDCCH order (PDCCH order) is a mechanism in which the terminal device in the RRC connected state directly triggers random access by using a PDCCH, and when the terminal device is handed over to a target cell, the PRACH procedure is triggered by using the PDCCH order. Alternatively, when the network device detects a connection problem or a link failure of the terminal device but there is downlink data to be transmitted, the network device may instruct, by using a PDCCH order, the terminal device to perform random access again. The network device implements uplink synchronization with the terminal device again by using the PDCCH order, and specifically, the uplink synchronization may be implemented by using a DCI format 1_0 (DCI format 1_0 or DCI 1_0). The DCI 1_0 may indicate allocation information of a downlink physical resource block (physical resource block, PRB) to notify the terminal device of resources on which data is received, or may be used to trigger physical uplink shared channel (physical uplink shared channel, PUSCH) transmission of an uplink and specify a related resource of the PUSCH transmission to a random access procedure. The DCI 1-0 is used to trigger, by using the PDCCH order, the terminal device to transmit a PRACH, and the DCI 1_0 is usually scrambled by using a C-RNTI, where the C-RNTI is used to identify a specific terminal device, and this field ensures that a trigger command is valid only for the terminal device, thereby avoiding conflicts between a plurality of users.

The network device transmits the DCI 1_0 to the specific terminal device by using the PDCCH order, and scrambling the DCI 1_0 by using the C-RNTI may ensure that a message is parsed only by the terminal device, where the DCI 1_0 includes information such as a PRACH resource indication field and a preamble index, so as to instruct the terminal device to transmit the PRACH on a designated resource. The terminal device transmits a preamble on the designated PRACH resource based on the DCI 1_0, to complete a random access attempt. The network device responds, by using a random access response (random access response, RAR) message, the PRACH transmitted by the terminal device, to complete the access procedure. In the RACH procedure based on the PDCCH order, a waiting step in a conventional random access procedure is bypassed, and an access delay is significantly reduced. APRACH resource location and a preamble index are specified to adapt to different network load and scenario requirements. A unique PRACH resource and preamble may be allocated to the terminal device, to reduce access conflicts between a plurality of users to a maximum extent. In a scenario in which users are dense, access requests may be effectively split by using a PDCCH order, thereby relieving PRACH conflicts. Low-latency random access trigger is provided for a high-mobility user (for example, internet of vehicles communication or train communication). Delay and failure probabilities during handover are reduced, so that connection stability is ensured.

As described above, if the network device provides one or more PRACH configurations (which are also referred to as second PRACH configurations) other than the basic PRACH configuration (which is referred to as a first PRACH configuration) for the terminal device supporting the higher version, that is, the network device provides an additional PRACH resource for the terminal device supporting the higher version, when the cases described above occurs, for example, the network device detects that an uplink of the terminal is out of synchronization or there is downlink data that needs to be transmitted to the terminal but the terminal device is not synchronized, how the network device triggers random access of the terminal device is not resolved currently.

Therefore, the embodiments of the present application provide the following method: a network device transmits first DCI to a terminal device, to trigger a random access procedure or indicate a first PRACH resource, so as to provide the terminal device with an additional random access opportunity or resource, which facilitates fast restoration of uplink synchronization, optimizes network resource allocation, and improves system flexibility.

Embodiments of the present application are described in detail below with reference to FIG. 2.

FIG. 2 is a schematic flowchart of a wireless communication method according to an embodiment of the present application. The method 200 shown in FIG. 2 may be performed by a terminal device and a network device. The terminal device may be for example the terminal device 120 shown in FIG. 1, and the network device may be for example the network device 110 shown in FIG. 1.

Referring to FIG. 2, in step 210, the network device transmits first DCI to the terminal device.

Correspondingly, in step 220, the terminal device receives the first DCI transmitted by the network device.

The first DCI is used to trigger a random access procedure or used to indicate a first PRACH resource. Optionally, the first PRACH resource may be a PRACH resource indicated by a first PRACH configuration and/or a PRACH resource indicated by a second PRACH configuration. The first PRACH configuration may be for example the foregoing basic PRACH configuration for a legacy terminal device (for example, a terminal device supporting a lower version), and the second PRACH configuration is for example the foregoing additional PRACH configuration for a specific terminal device (for example, a terminal device supporting a higher version). In other words, the PRACH resource indicated by the second PRACH configuration is an additional PRACH resource configured for the specific terminal device (for example, the terminal device supporting the higher version). In some implementations, the second PRACH configuration may be associated with an RRC state (for example, an RRC idle state, an RRC connected state, or an RRC inactive state) of the terminal device. For example, if a second PRACH configuration is associated with the RRC idle state, a PRACH resource indicated by the second PRACH configuration is applicable to a terminal device in the RRC idle state to perform random access. For another example, if a second PRACH configuration is associated with the RRC connected state, a PRACH resource indicated by the second PRACH configuration is applicable to a terminal device in the RRC connected state to perform random access. Optionally, the RRC state associated with the second PRACH configuration may be configured by the network device by using higher layer signaling.

In this case, optionally, the first DCI may include ninth information, where the ninth information is used to indicate whether the first PRACH resource is the PRACH resource indicated by the first PRACH configuration or the PRACH resource indicated by the second PRACH configuration. For example, the ninth information may be used for one or more of the following: indicating that the first PRACH resource is the PRACH resource indicated by the first PRACH configuration; indicating that the first PRACH resource is the PRACH resource indicated by the second PRACH configuration; triggering a random access procedure that is based on the PRACH resource indicated by the first PRACH configuration; or indicating an index or a sequence number of a PRACH configuration corresponding to the first PRACH resource. In addition, optionally, the ninth information may further include other information associated with the first PRACH resource (for example, the first PRACH resource indicated by the second PRACH configuration). In an example, when the first PRACH resource is the PRACH resource indicated by the second PRACH configuration, the index or the sequence number of the PRACH configuration corresponding to the first PRACH resource may indicate one of a plurality of second PRACH configurations, where a PRACH resource indicated by the second PRACH configuration is used by the terminal device to perform random access, in other words, the terminal device performs random access on the second PRACH configuration corresponding to the index or the sequence number indicated by the ninth information. For example, if a second PRACH configuration #1 is for a terminal device in the connected state, and a second PRACH configuration #2 is for a terminal device in the idle state, when the ninth information indicates the second PRACH configuration #1, it indicates that the terminal device in the connected state performs random access on a PRACH resource indicated by the second PRACH configuration #1; and when the ninth information indicates the second PRACH configuration #2, it indicates that the terminal device in the idle state performs random access on a PRACH resource indicated by the second PRACH configuration #2.

Optionally, the first DCI may include a first field, for example, the first field may be a frequency resource assignment field. Different values of the frequency resource assignment field may indicate different content, for example, indicating that the first PRACH resource is the PRACH resource indicated by the second PRACH configuration, indicating the index or the sequence number of the PRACH configuration corresponding to the first PRACH resource, or triggering the random access procedure on the first PRACH resource. The frequency resource assignment field carrying the ninth information may be compatible with an existing system, and a field in the first DCI is efficiently used.

A first DCI format may be for example DCI 1_0. In an implementation, the first DCI is scrambled based on a C-RNTI, and in this case, the first DCI may be the PDCCH order described above. In another implementation, the first DCI is scrambled based on a P-RNTI. When the first DCI is scrambled based on the P-RNTI, a terminal device in any RRC state can receive (for example, periodically receiving) the first DCI, so as to improve random access performance of the terminal device. In addition, some fields in the first DCI are properly used, so that a PRACH resource can be updated without additional overheads. It may be understood that, because a transmission interval of the first DCI scrambled by the P-RNTI may be relatively long, for the terminal device in the RRC connected state, update of the first DCI is relatively slow. In this case, a random access procedure of the terminal device may be triggered or another PRACH resource may be indicated with reference to the PDCCH order described above. In other words, the terminal device in the RRC connected state may receive the PDCCH order (that is, the DCI scrambled by the C-RNTI) to trigger the random access procedure or indicate a PRACH resource used in the random access procedure, or may receive the first DCI scrambled by the P-RNTI, to trigger the random access procedure or indicate a PRACH resource used in the random access procedure.

The DCI scrambled based on the P-RNTI usually includes a short message indication field, a short message (short message) field, a scheduling information field, a reserved bit (reserved bits), and the like. As shown in Table 1, the short message indication field usually includes two bits, and for content corresponding to a value of the two bits, reference may be for example made to Table 1.

TABLE 1

| Bit field | Short message indication |
|---|---|
| 00 | Reserved |
| 01 | Including only scheduling information |
| 10 | Including only a short message |
| 11 | Including both scheduling information and a short message |

When detecting the DCI scrambled by the P-RNTI, the terminal device performs a cyclic redundancy check (cyclic redundancy check, CRC), and then determines whether the DCI includes the short message, the scheduling information, or both the scheduling information and the short message. In other words, the terminal device needs to first read the short message indication field, and then determine content of another field based on a value of the two bits in the short message indication field.

The short message field in the DCI is usually eight bits, and if the DCI carries only scheduling information of paging, this field is maintained (or reserved).

The scheduling information field in the DCI usually carries information about an uplink resource associated with a paging message of the network device. For example, the scheduling information field may include one or more of the following:
frequency resource assignment (frequencyresource assignment): if only the short message is carried, this field is reserved, where a size of this field is related to a size of a control resource set (control resource set, CORESET) 0;
time resource assignment (time resource assignment): four bits, and if only the short message is carried, this field is reserved;
mapping from a virtual resource block (virtual resource blocks, VRB) to a physical resource block (Physical Resource Blocks, PRB) (VRB-to-PRB mapping): one bit, and if only the short message is carried, this field is reserved;
modulation and coding scheme (modulation and coding scheme): five bits, and if only the short message is carried, this field is reserved;
transport block (transport block, TB) scaling (TB scaling): two bits, and if only the short message is carried, this field is reserved; or
tracking reference signal (tracking reference signal, TRS) availability indication (TRS availability indication): if TRS-ResourceSetConfig is configured, this field is one bit, two bits, three bits, four bits, five bits, or six bits; otherwise, this field is 0 bit.

The DCI may further include the reserved bit (Reserved bits). For a shared spectrum channel access operation in a frequency range 1 or an operation in a frequency range (frequency range, FR) 2-2, the reserved bit is (8-M) bits; and for a cell in which shared spectrum channel access is not used, the reserved bit is (6-M) bits, where M is a quantity of bits of the “TRS availability indication” field.

Several possible implementations of the first DCI are described below in detail with reference to Embodiment 1 to Embodiment 5.

### Embodiment 1

In Embodiment 1, the first DCI may be scrambled based on the P-RNTI. The first DCI includes the short message indication field, the short message indication field is used to indicate first information, and the first information is related to random access. In other words, the first information related to the random access is carried in the short message indication field in the first DCI, so as to trigger the random access procedure or be used to indicate the first PRACH resource.

For example, the first information is used to indicate that: the first DCI includes only second information; the first DCI includes the short message and/or second information; the first DCI includes the scheduling information and/or second information; or the first DCI includes the scheduling information, the short message, and second information. The second information is used to trigger the random access procedure or used to indicate the first PRACH resource. For example, the first information may include two bits, and a value of the two bits is 00, 01, 10, or 11.

In an example, as shown in Table 2, a value of the short message indication field being 01 indicates that the first DCI includes only the scheduling information, a value of the short message indication field being 10 indicates that the first DCI includes the short message and/or the second information, and a value of the short message indication field being 11 indicates that the first DCI includes both the scheduling information and the short message. The second information is used to trigger the random access procedure or used to indicate the first PRACH resource.

TABLE 2

| Bit field | Short message indication |
|---|---|
| 00 | Reserved |
| 01 | Including only scheduling information |
| 10 | Including a short message and/or second information |
| 11 | Including both scheduling information and a short message |

For another example, as shown in Table 3, a value of the short message indication field being 01 indicates that the first DCI includes only the scheduling information, a value of the short message indication field being 10 indicates that the first DCI includes the short message, and a value of the short message indication field being 11 indicates that the first DCI includes both the scheduling information and the short message and/or the second information (that is, the first DCI may include the scheduling information and the short message, may include the scheduling information and the second information, or may include the scheduling information, the short message, and the second information). The second information is used to trigger the random access procedure or used to indicate the first PRACH resource.

TABLE 3

| Bit field | Short message indication |
|---|---|
| 00 | Reserved |
| 01 | Including only scheduling information |
| 10 | Including only a short message |
| 11 | Including both scheduling information and a short message |
| | and/or second information |

For another example, as shown in Table 4, a value of the short message indication field being 00 indicates that the first DCI includes the second information, a value of the short message indication field being 01 indicates that the first DCI includes the scheduling information, a value of the short message indication field being 10 indicates that the first DCI includes the short message, and a value of the short message indication field being 11 indicates that the first DCI includes both the scheduling information and the short message. The second information is used to trigger the random access procedure or used to indicate the first PRACH resource.

TABLE 4

| Bit field | Short message indication |
|---|---|
| 00 | Including only second information |
| 01 | Including only scheduling information |
| 10 | Including a short message |
| 11 | Including both scheduling information and a short message |

### Embodiment 2

In the implementation shown in Table 2 in Embodiment 1, the value of the short message indication field being 10 indicates that the first DCI includes the short message and/or the second information. In this case, the terminal device cannot determine, based on the value 10 of the short message indication field, whether the first DCI specifically includes the short message, the second information, or both the short message and the second information. Similarly, in the implementation shown in Table 3 in Embodiment 1, the value of the short message indication field being 11 indicates that the first DCI includes both the scheduling information and the short message and/or the second information. In this case, the terminal device cannot determine, based on the value 11 of the short message indication field, whether the first DCI specifically includes both the scheduling information and the short message, both the scheduling information and the second information, or all of the scheduling information, the short message, and the second information.

Therefore, in Embodiment 2, when the short message indication field indicates the first information, the first DCI may further include third information. For example, the third information is used to indicate one or more of the following states: the first DCI including the second information; the first DCI including no second information; the first DCI including the short message; the first DCI including no short message; the first DCI including only the second information; the first DCI including only the short message; or the first DCI including both the short message and the second information.

In an example, the third information may be one bit, and a value of the third information may include a first value or a second value. The first value is 1, and the second value is 0. Alternatively, the first value is 0, and the second value is 1. For example, the value of the third information being the first value indicates that the first DCI includes the second information, and the value of the third information being the second value indicates that the first DCI does not include the second information. For another example, the value of the third information being the first value indicates that the first DCI includes the short message, and the value of the third information being the second value indicates that the first DCI does not include the short message. For another example, the value of the third information being the first value indicates that the first DCI does not include the short message, and the value of the third information being the second value indicates that the first DCI does not include the second information.

For another example, the third information may be two bits. In this case, states indicated by the third information may be: including the short message, including the second information, or including both the short message and the second information. Different values of the third information indicate different states. Table 2 is used as an example, and the value of the short message indication field being 10 indicates that the first DCI includes the short message and/or the second information. In this case, the terminal device may determine, based on the value of the third information, whether the first DCI includes only the short message, only the second information, or both the short message and the second information. Table 3 is used as an example, and the value of the short message indication field being 11 indicates that the first DCI includes both the scheduling information and the short message and/or the second information. In this case, the terminal device may determine, based on the value of the third information, whether the first DCI includes both the scheduling information and the short message, both the scheduling information and the second information, or all of the scheduling information, the short message, and the second information.

### Embodiment 3

In Embodiment 3, the first DCI may include fourth information. For example, the fourth information may include one or more of the following: a random access preamble index (random access preamble index); an uplink (uplink, UL)/supplementary uplink (supplementary uplink, SUL) indicator (UL/SUL indicator); a synchronous signal physical broadcast channel (synchronous signal physical broadcast channel, SS/PBCH) index (SS/PBCH index), a PRACH mask index (PRACH Mask index); fifth information used to indicate time domain information of the first PRACH resource; sixth information used to indicate a subset index corresponding to the first PRACH resource in configured PRACH resources; or seventh information used to indicate whether the first PRACH resource is activated. In addition, optionally, the first DCI may further include the reserved bit.

First, the random access preamble index, the UL/SUL indicator, the SS/PBCH index, and the PRACH mask index are briefly described. The random access preamble index is configured based on ra-PreambleIndex in a higher layer protocol, and if the DCI carries only the short message, this field is reserved. If values in the “random access preamble index” field are not all 0, and the terminal device configures, in a cell, a supplementary uplink (supplementaryUplink) in a serving cell configuration (ServingCellConfig), a field of the UL/SUL indicator indicates, based on a protocol, an uplink carrier that is used to transmit a PRACH in the cell; otherwise, this field is reserved. If the DCI carries only the short message, this field is reserved. If values in the “random access preamble index” field are not all 0, a field of the SS/PBCH index indicates an SS/PBCH used to determine an RACH occasion of PRACH transmission; otherwise, this field is reserved. If only the short message is carried, this field is reserved. If values in the “random access preamble index” field are not all 0, a field of the PRACH mask index indicates, based on a protocol, that the RACH occasion associated with the SS/PBCH indicated by the “SS/PBCH index” field is used for PRACH transmission; otherwise, this field is reserved. If only the short message is carried, this field is reserved.

It may be understood that the PDCCH order described above usually also includes the random access preamble index, the UL/SUL indicator, the SS/PBCH index, and the PRACH mask index, where the PDCCH order described above is usually scrambled based on the C-RNTI. In some implementations, in Embodiment 3, the first DCI may be scrambled based on the C-RNTI, but different from the PDCCH order, the first DCI may further include the fifth information, the sixth information, and the seventh information. The fifth information, the sixth information, and the seventh information are associated with the PRACH resource indicated by the second PRACH configuration. In other words, a PRACH resource indicated by the fifth information, the sixth information, and the seventh information is the additional PRACH resource configured for the specific terminal device (for example, the terminal device supporting the higher version). Therefore, the first DCI scrambled by the C-RNTI in the embodiments of the present application may be further used to indicate related information of the PRACH resource indicated by the second PRACH configuration. The first DCI scrambled by the C-RNTI may be for a terminal device in the RRC connected state.

In some other implementations, in Embodiment 3, the first DCI may also be scrambled based on the P-RNTI. Similar to the PDCCH order scrambled based on the C-RNTI, the first DCI may also include one or more of the random access preamble index, the UL/SUL indicator, the SS/PBCH index, or the PRACH mask index, and/or include one or more of the fifth information, the sixth information, or the seventh information that is associated with the PRACH resource indicated by the second PRACH configuration. The first DCI scrambled by the P-RNTI may be for a terminal device in the RRC connected state, the RRC idle state, or the RRC inactive state.

The fifth information is used to indicate the time domain information of the first PRACH resource, and the time domain information for example includes information about a radio frame interval (or period) x and/or a radio frame offset y (that is, an offset, relative to a certain radio frame, of a radio frame in which a PRACH resource is located) (for example, indication sequence numbers of x and y). Here, y is obtained after a frame number of a radio frame in which the first PRACH resource is located modulo x, that is, n_{f} mod x=y, where n_{f} is the frame number of the radio frame in which the first PRACH resource is located, x is a radio frame interval of the first PRACH resource, and y is a radio frame offset. The radio frame interval x may be a parameter x shown in the table 6.3.3.2 in the protocol 38.211, and the radio frame offset y may be a parameter y shown in the table 6.3.3.2 in the protocol 38.211.

The sixth information is used to indicate the subset index corresponding to the first PRACH resource in the configured PRACH resources. If the network device configures, by using the second PRACH configuration, a plurality of additional PRACH resources for the terminal device supporting the higher version, and currently the first PRACH resource that needs to be indicated to the terminal device by using the first DCI for performing uplink access is a PRACH resource subset including several PRACH resources in the plurality of PRACH resources, the first DCI includes the sixth information to indicate an index of the PRACH resource subset, so that the terminal device determines, based on the index, the first PRACH resource used for performing uplink access.

Because the first DCI scrambled by the P-RNTI may be transmitted periodically, the first DCI may further include the seventh information, to indicate whether the first PRACH resource is activated.

### Embodiment 4

In Embodiment 4, the first DCI may be scrambled based on the P-RNTI. The first DCI may include the short message field. The fourth information described above may be carried in the short message field. For example, the short message field in the first DCI may include one or more of the following: a random access preamble index, an UL/SUL indicator, an SS/PBCH index, a PRACH mask index, fifth information, sixth information, or seventh information. Herein, the fourth information is carried in the short message field of the first DCI because there are usually remaining bits in the short message field, for example, the fifth bit to the eighth bit in the 8-bit short message field may remain, and therefore the fifth bit to the eighth bit in the short message field may be used to carry the fourth information.

In addition, the first DCI includes the reserved bit, and the fourth information may be carried in the reserved bit. For example, the reserved bit in the first DCI may include one or more of the following: a random access preamble index, an UL/SUL indicator, an SS/PBCH index, a PRACH mask index, fifth information, sixth information, or seventh information.

When the fourth information includes different parameters, different quantities of bits are required for carrying the fourth information. Therefore, optionally, the network device may transmit eighth information to the terminal device, and correspondingly, the terminal device receives the eighth information transmitted by the network device. For example, the eighth information may be higher layer signaling. The eighth information is used to indicate a location and/or a quantity of bits used to carry the fourth information in the first DCI. For example, the eighth information is used to indicate a location and/or a quantity of one or more bits used to carry the fourth information in the short message field or the reserved bit, that is, bits in the short message field or the reserved bit that are used to carry the fourth information are indicated by using the eighth information. In an example, it is assumed that the fourth information includes the seventh information and the seventh information is used to indicate whether the first PRACH resource is activated, and in this case, the eighth information may indicate which bit in the short message field or the reserved bit carries the seventh information, where a value of the bit being 0 indicates that the first PRACH resource is not activated, and a value of the bit being 1 indicates that the first PRACH resource is activated.

### Embodiment 5

In Embodiment 5, the first DCI may include the first field, and when a value of the first field is a first value, the first DCI is used to trigger the random access procedure or used to indicate the first PRACH resource. For example, the first field is a frequency resource assignment field. For another example, the first field is a time resource assignment field. For example, the first value may be a value existing when all bits in the first field are 1, or may be a value existing when all bits in the first field are 0.

In an example, when all bits in the frequency resource assignment field in the first DCI are 0, it indicates that the first DCI is used to trigger the random access procedure or used to indicate the first PRACH resource. All bits in the frequency resource assignment field being 0 is used to indicate that the first DCI is used to trigger the random access procedure or used to indicate the first PRACH resource, which may be compatible with an existing system, and a field in the first DCI may be efficiently used.

The method embodiments of the present application are described in detail above with reference to FIG. 1 and FIG. 2. Apparatus embodiments of the present application are described in detail below with reference to FIG. 3 to FIG. 5. It should be understood that the description of the method embodiments corresponds to the description of the apparatus embodiments, and therefore, for a part that is not described in detail, reference may be made to the foregoing method embodiments.

FIG. 3 is a schematic structural diagram of a terminal device according to an embodiment of the present application. The terminal device 300 shown in FIG. 3 may include a transceiver unit 310. The transceiver unit 310 is configured to receive first DCI transmitted by a network device, where the first DCI is used to trigger a random access procedure or used to indicate a first PRACH resource.

In some implementations, the first DCI is scrambled based on a paging radio network temporary identifier P-RNTI, or the first DCI is scrambled based on a cell radio network temporary identifier C-RNTI.

In some implementations, the first DCI includes a short message indication field, the short message indication field is used to indicate first information, and the first information is related to random access.

In some implementations, the first information is used to indicate that: the first DCI includes only second information; or the first DCI includes a short message and/or second information; or the first DCI includes scheduling information and/or second information. The second information is used to trigger the random access procedure or used to indicate the first PRACH resource.

In some implementations, the first information includes two bits, and a value of the two bits is 00, 01, 10, or 11.

In some implementations, when the short message indication field indicates the first information, the first DCI further includes third information, and the third information is used to indicate one or more of the following states: the first DCI including the second information; the first DCI including no second information; the first DCI including the short message; the first DCI including no short message; the first DCI including only the second information; the first DCI including only the short message; or the first DCI including both the short message and the second information.

In some implementations, the first DCI includes fourth information, and the fourth information includes one or more of the following: a random access preamble index, a UL/SUL indicator, an SS/PBCH index, a PRACH mask index, fifth information used to indicate time domain information of the first PRACH resource, sixth information used to indicate a subset index corresponding to the first PRACH resource in configured PRACH resources, or seventh information used to indicate whether the first PRACH resource is activated.

In some implementations, the first DCI includes a short message field or a reserved bit, and the fourth information is carried in the short message field or the reserved bit.

In some implementations, the first PRACH resource is a PRACH resource indicated by a first PRACH configuration or a PRACH resource indicated by a second PRACH configuration, and the PRACH resource indicated by the second PRACH configuration is an additional PRACH resource configured for a specific terminal device.

In some implementations, the transceiver unit 310 is further configured to receive, eighth information transmitted by the network device, where the eighth information is used to indicate a location of one or more bits used to carry the fourth information in the short message field or the reserved bit.

In some implementations, the first DCI includes ninth information, where the ninth information is used to indicate whether the first PRACH resource is the PRACH resource indicated by the first PRACH configuration or the PRACH resource indicated by the second PRACH configuration.

In some implementations, the second PRACH configuration is associated with an RRC state of the terminal device, and the RRC state associated with the second PRACH configuration is configured by the network device by using higher layer signaling.

In some implementations, the first DCI includes a first field, and when a value of the first field is a first value, the first DCI is used to trigger the random access procedure or used to indicate the first PRACH resource.

In some implementations, the first field is a frequency resource assignment field.

In some implementations, the first value is a corresponding value existing when all bits in the first field are 0.

It may be understood that the transceiver unit 310 may be for example a transceiver 530. In addition, optionally, the terminal device 300 further includes a processor 510 and a memory 520. For details, reference may be made to FIG. 5.

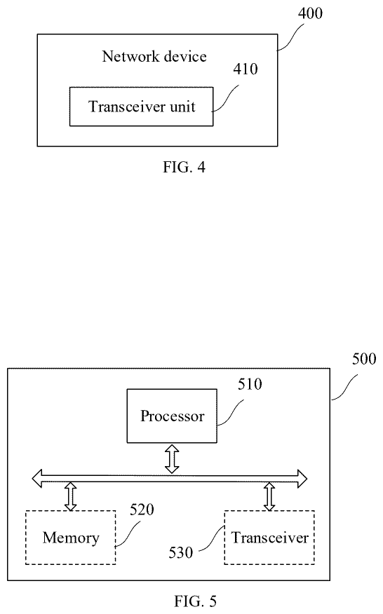

FIG. 4 is a schematic structural diagram of a network device according to an embodiment of the present application. The network device 400 shown in FIG. 4 may include a transceiver unit 410. The transceiver unit 410 is configured to transmit first DCI to a terminal device, where the first DCI is used to trigger a random access procedure or used to indicate a first PRACH resource.

In some implementations, the first DCI is scrambled based on a paging radio network temporary identifier P-RNTI, or the first DCI is scrambled based on a cell radio network temporary identifier C-RNTI.

In some implementations, the first DCI includes a short message indication field, the short message indication field is used to indicate first information, and the first information is related to random access.

In some implementations, the first information is used to indicate that: the first DCI includes only second information; or the first DCI includes a short message and/or second information; or the first DCI includes scheduling information and/or second information. The second information is used to trigger the random access procedure or used to indicate the first PRACH resource.

In some implementations, the first information includes two bits, and a value of the two bits is 00, 01, 10, or 11.

In some implementations, when the short message indication field indicates the first information, the first DCI further includes third information, and the third information is used to indicate one or more of the following states: the first DCI including the second information; the first DCI including no second information; the first DCI including the short message; the first DCI including no short message; the first DCI including only the second information; the first DCI including only the short message; or the first DCI including both the short message and the second information.

In some implementations, the first DCI includes fourth information, and the fourth information includes one or more of the following: a random access preamble index, a UL/SUL indicator, an SS/PBCH index, a PRACH mask index, fifth information used to indicate time domain information of the first PRACH resource, sixth information used to indicate a subset index corresponding to the first PRACH resource in configured PRACH resources, or seventh information used to indicate whether the first PRACH resource is activated.

In some implementations, the first DCI includes a short message field or a reserved bit, and the fourth information is carried in the short message field or the reserved bit.

In some implementations, the first PRACH resource is a PRACH resource indicated by a first PRACH configuration or a PRACH resource indicated by a second PRACH configuration, and the PRACH resource indicated by the second PRACH configuration is an additional PRACH resource configured for a specific terminal device.

In some implementations, the transceiver unit 410 is further configured to transmit eighth information to the terminal device, where the eighth information is used to indicate a location of one or more bits used to carry the fourth information in the short message field or the reserved bit.

In some implementations, the first DCI includes ninth information, where the ninth information is used to indicate whether the first PRACH resource is the PRACH resource indicated by the first PRACH configuration or the PRACH resource indicated by the second PRACH configuration.

In some implementations, the second PRACH configuration is associated with an RRC state of the terminal device, and the RRC state associated with the second PRACH configuration is configured by the network device by using higher layer signaling.

In some implementations, the first DCI includes a first field, and when a value of the first field is a first value, the first DCI is used to trigger the random access procedure or used to indicate the first PRACH resource.

In some implementations, the first field is a frequency resource assignment field.

In some implementations, the first value is a corresponding value existing when all bits in the first field are 0.

It may be understood that the transceiver unit 410 may be for example a transceiver 530. In addition, optionally, the network device 400 further includes a processor 510 and a memory 520. For details, reference may be made to FIG. 5.

FIG. 5 is a schematic structural diagram of an apparatus for communication according to an embodiment of the present application. The dashed lines shown in FIG. 5 indicate that the unit or module is optional. The apparatus 500 may be configured to implement the method described in the foregoing method embodiments. The apparatus 500 may be for example a chip, a terminal device, or a network device.

The apparatus 500 may include one or more processors 510. The processor 510 may support the apparatus 500 in implementing the method described in the foregoing method embodiments. The processor 510 may be a general-purpose processor or a dedicated processor. For example, the processor 510 may be a central processing unit (central processing unit, CPU). Alternatively, the processor 510 may be another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or may be any conventional processor or the like.

The apparatus 500 may further include one or more memories 520. The memory 520 stores a program, and the program may be executed by the processor 510, so that the processor 510 executes the method described in the foregoing method embodiments. The memory 520 may be separate from the processor 510 or may be integrated into the processor 510.

The apparatus 500 may further include a transceiver 530. The processor 510 may communicate with another device or chip by using the transceiver 530. For example, the processor 510 may transmit data to and receive data from another device or chip by using the transceiver 530.

An embodiment of the present application further provides a communications system. The communications system includes the terminal device and the network device that are described above. In some implementations, the system further includes another device that interacts with the terminal device and the network device.

An embodiment of the present application further provides a computer-readable storage medium for storing a program. The computer-readable storage medium may be applied to a terminal device or a network device provided in embodiments of the present application, and the program causes a computer to execute a method executed by the terminal device or the network device in various embodiments of the present application.

An embodiment of the present application further provides a computer program product. The computer program product includes a program. The computer program product may be applied to a terminal device or a network device provided in embodiments of the present application, and the program causes a computer to execute a method executed by the terminal device or the network device in various embodiments of the present application.

An embodiment of the present application further provides a computer program. The computer program may be applied to a terminal device or a network device provided in embodiments of the present application, and the computer program causes a computer to execute a method executed by the terminal device or the network device in various embodiments of the present application.

It should be understood that the terms “system” and “network” in embodiments of the present application may be used interchangeably. In addition, the terms used in the present application are only used to explain specific embodiments of the present application, and are not intended to limit the present application. The terms “first”, “second”, “third”, “fourth”, and the like in the specification, claims, and accompanying drawings of the present application are used to distinguish between different objects, rather than to describe a specific order. In addition, the terms “include” and “have” and any variations thereof are intended to cover a non-exclusive inclusion.

In embodiments of the present application, “indication” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, “B corresponding to A” means that B is associated with A, and B may be determined based on A. However, it should be further understood that, determining B based on A does not mean determining B based only on A, but instead, B may be determined based on A and/or other information.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “pre-definition” or “pre-configuration” may be implemented by pre-storing corresponding code or a corresponding table in a device (for example, including a terminal device and a network device) or in other manners that can be used for indicating related information. A specific implementation thereof is not limited in the present application. For example, pre-definition may refer to being defined in a protocol.

In embodiments of the present application, the “protocol” may be a standard protocol in the communications field, which may include, for example, an LTE protocol, an NR protocol, and a related protocol applied to a future communications system. This is not limited in the present application.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined based on functions and internal logic of the processes, and should not be construed as any limitation on the implementation processes of the embodiments of the present application.

In several embodiments provided in the present application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be indirect couplings or communication connections implemented through some interfaces, apparatus, or units, and may be implemented in electronic, mechanical, or other forms.

Units described as separate components may be or may not be physically separate, and components displayed as units may be or may not be physical units, that is, may be located in one place or distributed on a plurality of network units. Some or all of the units may be selected based on actual requirements to achieve objectives of solutions of the embodiments.

In addition, functional units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When the software is used to implement the embodiments, all or some of the embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by a computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A communication method, comprising:
receiving, by a terminal device, first downlink control information (DCI) from a network device, wherein the first DCI is used to trigger a random access procedure or used to indicate a first physical random access channel (PRACH) resource.

2. The method according to claim 1, wherein
the first DCI is scrambled based on a paging radio network temporary identifier (P-RNTI), or
the first DCI is scrambled based on a cell radio network temporary identifier (C-RNTI).

3. The method according to claim 1, wherein the first DCI comprises a short message indication field, the short message indication field indicates first information, and the first information is related to random access.

4. The method according to claim 3, wherein the first information indicates that:
the first DCI comprises only second information; or
the first DCI comprises at least one of a short message or second information; or
the first DCI comprises at least one of scheduling information or second information; or
the first DCI comprises scheduling information, a short message, and second information, wherein
the second information is used to trigger the random access procedure or used to indicate the first PRACH resource.

5. The method according to claim 4, wherein the first information comprises two bits, and a value of the two bits is 00, 01, 10, or 11.

6. The method according to claim 3, wherein when the short message indication field indicates the first information, the first DCI further comprises third information, and the third information indicates one or more of following states:
the first DCI comprising second information;
the first DCI comprising no second information;
the first DCI comprising short message;
the first DCI comprising no short message;
the first DCI comprising only second information;
the first DCI comprising only short message; or
the first DCI comprising short message and second information.

7. The method according to claim 1, wherein the first DCI comprises fourth information, and the fourth information comprises one or more of following:
a random access preamble index;
an uplink (UL) or supplementary uplink (SUL) indicator;
a synchronous signal physical broadcast channel (SS/PBCH) index;
a PRACH mask index;
fifth information used to indicate time domain information of the first PRACH resource;
sixth information used to indicate a subset index corresponding to the first PRACH resource in configured PRACH resources; or
seventh information used to indicate whether the first PRACH resource is activated.

8. The method according to claim 7, wherein the first DCI comprises a short message field or a reserved bit, and the fourth information is carried in the short message field or the reserved bit.

9. The method according to claim 1, wherein the method further comprises:
receiving, by the terminal device, eighth information transmitted by the network device, wherein the eighth information indicates at least one of a location or a quantity of bits used to carry fourth information in the first DCI.

10. The method according to claim 1, wherein the first PRACH resource is a PRACH resource indicated by a first PRACH configuration or a PRACH resource indicated by a second PRACH configuration, and the PRACH resource indicated by the second PRACH configuration is an additional PRACH resource configured for a specific terminal device.

11. The method according to claim 1, wherein the first DCI comprises ninth information, and the ninth information is used for one or more of following:
indicating that the first PRACH resource is the PRACH resource indicated by a first PRACH configuration;
indicating that the first PRACH resource is the PRACH resource indicated by a second PRACH configuration;
triggering a random access procedure that is based on the PRACH resource indicated by the first PRACH configuration; or
indicating an index or a sequence number of a PRACH configuration corresponding to the first PRACH resource.

12. The method according to claim 11, wherein the first DCI comprises a first field, and the ninth information is carried in the first field.

13. The method according to claim 12, wherein the first field is a frequency resource assignment field.

14. The method according to claim 10, wherein the second PRACH configuration is associated with a radio resource control (RRC) state of the terminal device, and the RRC state associated with the second PRACH configuration is configured by the network device by using higher layer signaling.

15. The method according to claim 1, wherein the first DCI comprises a first field, and when a value of the first field is a first value, the first DCI is used to trigger the random access procedure or used to indicate the first PRACH resource.

16. The method according to claim 15, wherein the first field is a frequency resource assignment field.

17. The method according to claim 15, wherein the first value is a corresponding value existing when all bits in the first field are 0.

18. A communication method, comprising:
transmitting, by a network device, first downlink control information (DCI) to a terminal device, wherein the first DCI is used to trigger a random access procedure or used to indicate a first physical random access channel (PRACH) resource.

19. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving first downlink control information (DCI) from a network device, wherein the first DCI is used to trigger a random access procedure or used to indicate a first physical random access channel (PRACH) resource.

20. The apparatus according to claim 19, wherein
the first DCI is scrambled based on a paging radio network temporary identifier (P-RNTI), or
the first DCI is scrambled based on a cell radio network temporary identifier (C-RNTI).
